(19) United States
(12) Patent Application Publication
(10) Pub. No.: US 2026/0021417 A1
(43) Pub. Date: Jan. 22, 2026

(54) Video Game Controller Joystick Head Movement Device

(71) Applicant: Charles Williams, New York, NY (US)

(72) Inventor: Charles Williams, New York, NY (US)

(21) Appl. No.: 18/897,695

(22) Filed: Sep. 26, 2024

Related U.S. Application Data
(60) Provisional application No. 63/672,802, filed on Jul. 18, 2024.

(51) Int. Cl. A63F 13/98

(52) U.S. Cl. CPC A63F 13/98

(57) ABSTRACT

A video game controller joystick head movement device is provided. The device comprises a first half and a second half. Each half is designed to attach securely to the separate joystick head of a video game controller through a convex, spherical body. The two halves are adjustable and can either compress or tension the joystick heads when connected via a fastening arm of the first half and a receiving area of the second half. This allows for continuous in-game character movement without the need for additional user input.

### CROSS-REFERENCE TO RELATED APPLICATION

The present application claims priority to, and the benefit of, U.S. Provisional Application No. 63/672,802, which was filed on Jul. 18, 2024, and is incorporated herein by reference in its entirety.

### FIELD OF THE INVENTION

The present invention relates generally to the field of video game controller accessories. More specifically, the present invention relates to a video game controller joystick head movement device that can be applied to both joysticks of a video game controller to ensure both joysticks are positioned to produce in-game character movement without user input after applying the device to a video game controller. Accordingly, the present disclosure makes specific reference thereto. Nonetheless, it is to be appreciated that aspects of the present invention are also equally applicable to other like applications, devices, and methods of manufacture.

### BACKGROUND

Many gamers often find themselves in situations where they need to momentarily step away from their gaming sessions to handle real-life tasks and responsibilities. Whether it's answering the door, attending to children or pets, preparing a quick snack, or taking a short break, these interruptions are a common part of everyday life. However, in many games, leaving an in-game character idle for even a short period can have significant consequences. Players might face in-game penalties, such as losing valuable progress, being automatically removed from a session, or even suffering negative impacts on their character's performance. These risks are particularly high in competitive games or scenarios where timing and continuous participation are crucial.

To avoid such outcomes, some players resort to various strategies to keep their in-game character active during their absence. These strategies might include setting up automated macros, placing objects on their keyboard or controller to simulate movement, or relying on third-party software to prevent their character from becoming idle. Unfortunately, these makeshift solutions are often unreliable and come with their own set of risks. They can fail to keep the character moving as intended, resulting in the very penalties players were trying to avoid. Moreover, some of these methods may violate the game's terms of service, leading to potential disciplinary action from the game developers, such as temporary suspensions or permanent bans. Consequently, gamers are left in a difficult position, balancing the need to manage real-life interruptions with the risks of leaving their in-game character unattended.

Therefore, there exists a long-felt need in the art for a device that allows a user step away from a video game temporarily without facing in-game consequences, penalties, discipline, etc. Further, there exists a long-felt need in the art for a video game controller joystick head movement device that can be applied to the joysticks of a controller. More specifically, there exists a long-felt need in the art for a video game controller joystick head movement device that can be applied to the joysticks of a controller in order to ensure an in-game character continues moving without additional input needed by the user.

The subject matter disclosed and claimed herein, in one embodiment thereof, comprises a video game controller joystick head movement device. The device comprises a first half and a second half. Each half is designed to attach securely to the separate joystick head of a video game controller through a convex, spherical body. The two halves are adjustable and can either compress or tension the joystick heads when connected via a fastening arm of the first half and a receiving area of the second half. This allows for continuous in-game character movement without the need for additional user input.

In this manner, the video game controller joystick head movement device of the present invention accomplishes all the forgoing objectives and provides a device that allows a user to step away from a video game temporarily without facing in-game consequences, penalties, discipline, etc. More specifically, the device can be applied to the joysticks of a controller during use such that the joysticks are moved towards each other to create in-game character movement. This ensures the in-game character continues moving without additional input needed by the user.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a video game controller joystick head movement device comprised of a first half that removably and adjustably attaches to a second half. The first half is comprised of a body that can be placed over a first joystick head. In one embodiment, the body is secured to the joystick head via snapping over the joystick head. In another embodiment, the body is comprised of at least one interior fastener. The inclusion of the fastener (and/or snap-fit construction of the body) prevents stick drift of the joystick head, which is common with other makeshift devices used for the same purpose.

The device is comprised of a second half that removably and adjustably attaches to the first half. The second half is comprised of a body that can be placed over a second joystick head. In one embodiment, the body is secured to the joystick head via snapping over the joystick head. In another embodiment, the body is comprised of at least one interior fastener. The inclusion of the fastener (and/or snap-fit construction of the body) prevents stick drift of the joystick head, which is common with other makeshift devices used for the same purpose.

After each is secured to two joystick heads of a controller, the first half and second half can be attached to one another in compression (or tension in a different embodiment) such that each joystick head is pulled towards (or away from, in a tension embodiment) each other to create in-game character movement/motion. More specifically, the first half is comprised of at least one fastening arm and the second half is comprised of at least one receiving area that receives the fastening arm, wherein the distance between the bodies can be incrementally and securely adjusted via pushing the arm into the receiving area or pulling the arm out of the receiving area, wherein the arm is automatically secured within the receiving area in this position.

The present invention is also comprised of a method of using the device. First, a device is provided comprised of a first half comprised of a first body and a fastening arm and a second half comprised of a second body and a receiving area. Then, the body of the first half can be secured to/around a first joystick head of a video game controller and the body of the second half can be secured to/around a second joystick of a video game controller. Then, the fastening arm of the first half can be secured within the receiving area of the second half such that both joystick heads are pulled towards each other (in compression) such that movement of an in-game character occurs as a result of the movement of the joysticks. In a second method of use, both joystick heads are pushed away from each other (in tension) such that movement of an in-game character occurs as a result of the movement of the joysticks

Accordingly, the video game controller joystick head movement device of the present invention is particularly advantageous as it provides a device that allows a user to step away from a video game temporarily without facing in-game consequences, penalties, discipline, etc. More specifically, the device can be applied to the joysticks of a controller during use such that the joysticks are moved towards each other to create in-game character movement. This ensures the in-game character continues moving without additional input needed by the user. In this manner, the video game controller joystick head movement device overcomes the limitations of existing methods and devices known in the art used to allow a user to ensure in-game character movement without user input.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a video game controller joystick head movement device of the present invention with the first half and the second half separated in accordance with the disclosed architecture;

FIG. 2 illustrates a perspective view of one potential embodiment of a video game controller joystick head movement device of the present invention with the first half and the second half connected and above a pair of video game controller joysticks in accordance with the disclosed architecture;

FIG. 3 illustrates a perspective view of one potential embodiment of a video game controller joystick head movement device of the present invention with the first half and the second half connected and attached to a pair of video game controller joysticks in accordance with the disclosed architecture;

FIG. 4 illustrates a flowchart of a method of using one potential embodiment of a video game controller joystick head movement device of the present invention in accordance with the disclosed architecture; and

FIG. 5 illustrates a flowchart of a method of using one potential embodiment of a video game controller joystick head movement device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that allows a user to step away from a video game temporarily without facing in-game consequences, penalties, discipline, etc. Further, there exists a long-felt need in the art for a video game controller joystick head movement device that can be applied to the joysticks of a controller. More specifically, there exists a long-felt need in the art for a video game controller joystick head movement device that can be applied to the joysticks of a controller in order to ensure an in-game character continues moving without additional input needed by the user.

The present invention, in one exemplary embodiment, is comprised of a video game controller joystick head movement device. The device is comprised of a first half that removably and adjustably attaches to a second half, wherein the first half is comprised of a body that can be placed over a first joystick head. In one embodiment, the body is secured to the joystick head via snapping over the joystick head. In another embodiment, the body is comprised of at least one interior fastener. The inclusion of the fastener (and/or snap-fit construction of the body) prevents stick drift of the joystick head, which is common with other makeshift devices used for the same purpose.

The device is comprised of a second half that removably and adjustably attaches to the first half. The second half is comprised of a body that can be placed over a second joystick head. In one embodiment, the body is secured to the joystick head via snapping over the joystick head. In another embodiment, the body is comprised of at least one interior fastener. The inclusion of the fastener (and/or snap-fit construction of the body) prevents stick drift of the joystick head, which is common with other makeshift devices used for the same purpose.

After each is secured to two joystick heads of a controller, the first half and second half can be attached to one another in compression (or tension in a different embodiment) such that each joystick head is pulled towards (or away from, in a tension embodiment) each other to create in-game character movement/motion. More specifically, the first half is comprised of at least one fastening arm and the second half is comprised of at least one receiving area that receives the fastening arm. Further, the distance between the bodies can be incrementally and securely adjusted via pushing the arm into the receiving area or pulling the arm out of the receiving area, wherein the arm is automatically secured within the receiving area in this position.

The present invention is also comprised of a method of using the device. First, a device is provided comprised of a first half comprised of a first body and a fastening arm and a second half comprised of a second body and a receiving area. Then, the body of the first half can be secured to/around a first joystick head of a video game controller and the body of the second half can be secured to/around a second joystick of a video game controller. Then, the fastening arm of the first half can be secured within the receiving area of the second half such that both joystick heads are pulled towards each other (in compression) such that movement of an in-game character occurs as a result of the movement of the joysticks. In a second method of use, both joystick heads are pushed away from each other (in tension) such that movement of an in-game character occurs as a result of the movement of the joysticks

Accordingly, the video game controller joystick head movement device of the present invention is particularly advantageous as it provides a device that allows a user to step away from a video game temporarily without facing in-game consequences, penalties, discipline, etc. More specifically, the device can be applied to the joysticks of a controller during use such that the joysticks are moved towards each other to create in-game character movement. This ensures the in-game character continues moving without additional input needed by the user. In this manner, the video game controller joystick head movement device overcomes the limitations of existing methods and devices known in the art used to allow a user to ensure in-game character movement without user input.

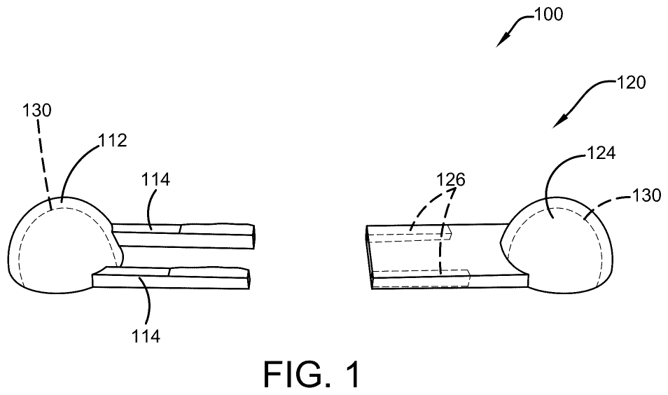

Referring initially to the drawings, FIG. 1 illustrates a perspective view of one potential embodiment of a video game controller joystick head movement device 100 of the present invention with the first half 110 and the second half 120 separated in accordance with the disclosed architecture. The device 100 is comprised of a first half 110 that removably and adjustably attaches to a second half 120. The device 100 is preferably made from a rigid or semi-rigid plastic material, but may be made from any material. The first half 110 is comprised of a body 112. The body 112 is preferably comprised of a convex, spherical shape such that it can be placed over a first joystick head 10. In one embodiment, the body 112 is secured to the joystick head 10 via snapping over the joystick head 10. In another embodiment, the body 112 is comprised of at least one interior fastener 130. The fastener 130 is preferably positioned on the underside of the body 112 such that the body 112 is secured to/around the joystick head 10. The fastener 130 may include but is not limited to a clip, a texture, a non-slip material (such as but not limited to a textured or non-textured rubber), etc. The inclusion of the fastener 130 (and/or snap-fit construction of the body 112) prevents stick drift of the joystick head 10, which is common with other makeshift devices used for the same purpose.

The device 100 is comprised of a second half 120 that removably and adjustably attaches to the first half 110. The second half 120 is comprised of a body 122. The body 122 is preferably comprised of a convex, spherical shape such that it can be placed over a second joystick head 10. In one embodiment, the body 122 is secured to the joystick head 10 via snapping over the joystick head 10. In another embodiment, the body 122 is comprised of at least one interior fastener 130. The fastener 130 is preferably positioned on the underside the body 122 such that the body 122 is secured to/around the joystick head 10. The fastener 130 may include but is not limited to a clip, a texture, a non-slip material (such as but not limited to a textured or non-textured rubber), etc. The inclusion of the fastener 130 (and/or snap-fit construction of the body 122) prevents stick drift of the joystick head 10, which is common with other makeshift devices used for the same purpose.

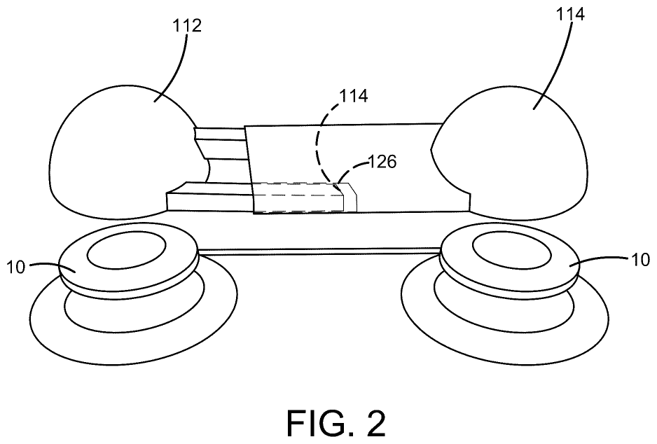

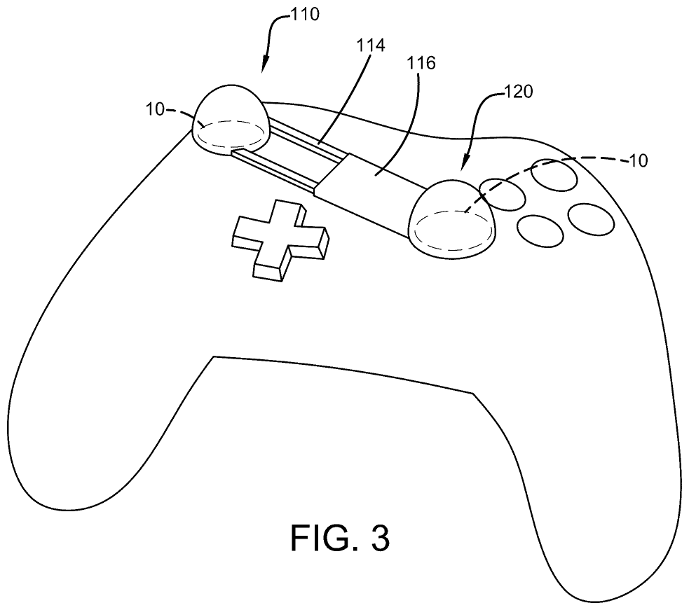

After each is secured to two joystick heads 10 of a controller, the first half 110 and second half 120 can be attached to one another (as seen in FIG. 2) in compression (or tension in a different embodiment) such that each joystick head 10 is pulled towards (or away from, in a tension embodiment) each other to create in-game character movement/motion, as seen in FIG. 3. More specifically, the first half 110 is comprised of at least one fastening arm 114 and the second half 120 is comprised of at least one receiving area 124 that receives the fastening arm 114. In the preferred embodiment, the fastening arm 114 is a notched arm (i.e., geared) and the receiving area 124 is a notched (i.e., geared) receiving area. In this manner, the distance between the bodies 112,122 can be incrementally and securely adjusted via pushing the arm 114 into the receiving area 124 or pulling the arm 114 out of the receiving area 124, wherein the arm 114 is automatically secured within the receiving area 124 in this position.

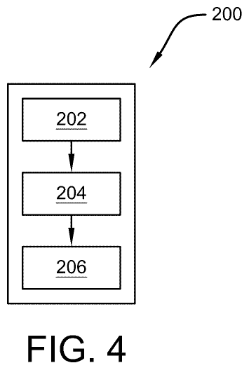

The present invention is also comprised of a method of using 200 the device 100, as seen in FIG. 4. First, a device 100 is provided comprised of a first half 110 comprised of a first body 112 and a fastening arm 114 and a second half 120 comprised of a second body 122 and a receiving area 124 [Step 202]. Then, the body 112 of the first half 110 can be secured to/around a first joystick head 10 of a video game controller and the body 122 of the second half 120 can be secured to/around a second joystick 10 of a video game controller [Step 204]. Then, the fastening arm 114 of the first half 110 can be secured within the receiving area 124 of the second half 120 such that both joystick heads 10 are pulled towards each other (in compression) such that movement of an in-game character occurs as a result of the movement of the joysticks 10 [Step 206].

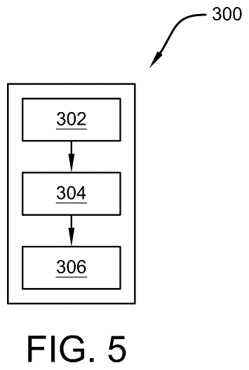

The present invention is also comprised of a second method of using 300 the device 100, as seen in FIG. 5. First, a device 100 is provided comprised of a first half 110 comprised of a first body 112 and a fastening arm 114 and a second half 120 comprised of a second body 122 and a receiving area 124 [Step 302]. Then, the body 112 of the first half 110 can be secured to/around a first joystick head 10 of a video game controller and the body 122 of the second half 120 can be secured to/around a second joystick 10 of a video game controller [Step 304]. Then, the fastening arm 114 of the first half 110 can be secured within the receiving area 124 of the second half 120 such that both joystick heads 10 are pushed away from each other (in tension) such that movement of an in-game character occurs as a result of the movement of the joysticks 10 [Step 306].

It should be appreciated that the bodies 112,122 may be any shape, size, and configuration that allows for secure attachment to a joystick head 10.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “video game controller joystick head movement device” and “device” are interchangeable and refer to the video game controller joystick head movement device 100 of the present invention.

Notwithstanding the forgoing, the video game controller joystick head movement device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the video game controller joystick head movement device 100 as shown in the FIGS. are for illustrative purposes only, and that many other sizes and shapes of the video game controller joystick head movement device 100 are well within the scope of the present disclosure. Although the dimensions of the video game controller joystick head movement device 100 are important design parameters for user convenience, the video game controller joystick head movement device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A video game controller joystick head movement device comprising:
a first half comprised of a first body and a fastening arm; and
a second half comprised of a second body comprised of a receiving area that receives the fastening arm.

2. The video game controller joystick head movement device of claim 1, wherein the device is comprised of a rigid plastic material.

3. The video game controller joystick head movement device of claim 1, wherein the first body is comprised of a convex, spherical first body.

4. The video game controller joystick head movement device of claim 1, wherein the second body is comprised of a convex, spherical second body.

5. The video game controller joystick head movement device of claim 1, wherein the fastening arm is comprised of a notched fastening arm.

6. The video game controller joystick head movement device of claim 1, wherein the receiving area is comprised of a notched receiving area.

7. A video game controller joystick head movement device comprising:
a first half comprised of a first body and a fastening arm, the first body comprised of a first interior fastener; and
a second half comprised of a second body comprised of a receiving area that receives the fastening arm, the first body comprised of a second interior fastener.

8. The video game controller joystick head movement device of claim 7, wherein the device is comprised of a semi-rigid plastic material.

9. The video game controller joystick head movement device of claim 7, wherein the first body is comprised of a convex, spherical first body.

10. The video game controller joystick head movement device of claim 7, wherein the second body is comprised of a convex, spherical second body.

11. The video game controller joystick head movement device of claim 7, wherein the first interior fastener is positioned on an underside of the first body.

12. The video game controller joystick head movement device of claim 7, wherein the first interior fastener is comprised of a clip, a texture, or a non-slip material.

13. The video game controller joystick head movement device of claim 7, wherein the second interior fastener is positioned on an underside of the second body.

14. The video game controller joystick head movement device of claim 7, wherein the first interior fastener is comprised of a clip, a texture, or a non-slip material.

15. The video game controller joystick head movement device of claim 7, wherein the fastening arm is comprised of a geared fastening arm.

16. The video game controller joystick head movement device of claim 7, wherein the receiving area is comprised of a geared receiving area.

17. A method of using a video game controller joystick head movement device, the method comprising:
providing a video game controller joystick head movement device comprised of a first half comprised of a first body and a fastening arm, and a second half comprised of a second body and a receiving area;
securing the first body to a first joystick head of a video game controller and securing the second body to a second joystick head of the video game controller; and
securing the fastening arm within the receiving area such that the first joystick and the second joystick are pulled towards each other or pushed away from each other.

18. The method of using a video game controller joystick head movement device of claim 17, wherein the fastening arm is comprised of a geared fastening arm.

19. The method of using a video game controller joystick head movement device of claim 17, wherein the receiving area is comprised of a geared receiving area.

20. The method of using a video game controller joystick head movement device of claim 17, wherein the first body is comprised of a convex, spherical body and the second body is comprised of a convex, spherical body.
